(19) United States
(12) Patent Application Publication
(10) Pub. No.: US 2007/0177553 A1
(43) Pub. Date: Aug. 2, 2007

(54) Apparatus, method and computer program product providing efficient signaling of user allocations in an optimum manner

(75) Inventors: Frank Frederiksen, Klarup (DK); Troels Kolding, Klarup (DK)

Correspondence Address: HARRINGTON & SMITH, PC, 4 RESEARCH DRIVE, SHELTON, CT, 06484-6212, US

(73) Assignee: Nokia Corporation

(21) Appl. No.: 11/701,060

(22) Filed: Jan. 31, 2007

Related U.S. Application Data
(60) Provisional application No. 60/764,116, filed on Jan. 31, 2006.

(51) Int. Cl. H04B 7/216

(52) U.S. Cl. 370/335

(57) ABSTRACT

An allocation of M network allocations (e.g., physical resource blocks) among N users is by a signaling word having a maximum number of bits given by ceil(M*log 2(N+1)). The signaling word is sent to users, who determine the resources allocated to them from the signaling word. In an embodiment, the signaling word is a series of binary index numbers, each index number assigned to one user, and the network allocations are stored in a known order in a list. The position of the index number in the signaling word, in view of the list, gives the network allocation to that user index number. For example, a user assigned the index number at the kth position in the signaling word is allocated the network allocation at a corresponding kth position of the stored list. This uses fewer signaling bits than the known prior art disclosed herein.

### CROSS REFERENCE TO RELATED APPLICATION:

This patent application claims priority under 35 U.S.C. §119(e) from Provisional Patent Application No.: 60/764116, filed Jan. 31, 2006, the disclosure of which is incorporated by reference herein in its entirety.

### TECHNICAL FIELD

The teachings in accordance with the exemplary embodiments of this invention relate generally to wireless communications systems and devices and, more specifically, to packet mode transmissions of data between a wireless network and a user equipment (UE), such as a cellular phone.

### BACKGROUND

An aspect of the long term evolution (LTE) of 3GPP, which may at times be referred to as 3.9 G, relates to the signaling of frequency domain packet scheduling decisions. An example of a working assumption in this regard is that all frequency domain packet scheduling decisions are based on allocations on a grouped basis, that is, a particular user is only given or allocated a continuous resource in the frequency domain. However, in most cases this will not provide an optimum solution. One possible scenario that may arise if this approach is followed would allow for full flexible resource allocation within the number of user frequency partitions or “chunks” that are available within the system bandwidth.

Reference in this regard may be had in a proposal for a signaling schemes for frequency domain allocation: R1-051064, “Resource Block bandwidth for based EUTRA downlink in localized mode”, 3GPP TSG-RAN WG1 Meeting #42bis, San Diego, Calif., U.S.A., 10-14 Oct. 2005, Panasonic. This proposal describes the signaling requirements on a per-user basis. FIGS. 1 and 2 of this patent application reproduce FIG. 1 and Tables 2, 3 and 4, respectively, from R1-051064, and show an example of a proposed physical channel structure and the corresponding physical channel parameters, respectively.

As is stated in R1-051064, a sub-frame of 0.5 ms duration consists of 7 OFDM symbols [OFDM=orthogonal frequency division multiplex], where every other sub-carrier of the first OFDM symbol in each sub-frame carries a common pilot. The remaining symbols are used for data transmission. Control signaling overhead is not considered. In total, 300 or 600 sub-carriers for 5 MHz or 10 MHz, respectively, are allocated for transmission, where N adjacent sub-carriers build a sub-band. Hence, a Resource Block (RB) spans over one sub-band and one sub-frame. The results of simulations performed for various sub-band (Resource Block) sizes are shown in Tables 3 and 4 of FIG. 2 herein. The link adaptation (MCS selection) and user allocation are performed per single resource block, i.e., scheduling is performed in the frequency domain as well as in time domain based on proportional fairness.

### SUMMARY

In an exemplary aspect of the invention there is a method that includes obtaining an ordered list of M network allocations each in a kth scheduling position of the list, assigning an index number to each of N users, and for each kth position of the list, associating one of the index numbers with the network allocation at that kth position of the list. Then, a signaling word having a maximum of ceil(M*log 2(N+1)) bits is generated, wherein N and M are each integers greater than one and the function ceil rounds to a next highest integer. The signaling word includes the index numbers sequenced according to their respective kth position in the list. The signaling word is transmitted to the N users.

In another exemplary aspect of the invention there is a computer program product embodied on a memory and executable by a processor to generate a signaling word by performing actions that include assigning an index number to individual ones of N users, associating the index numbers with each of M network allocations in an ordered list, determining a kth scheduling position in the list for each of the associated index numbers; and outputting a signaling word. The signaling word includes the index numbers sequenced according to their respective kth position in the list and has a maximum of ceil(M*log 2(N+1)) bits, where N and M are each integers greater than one and the function ceil rounds to a next highest integer.

In another exemplary aspect of the invention there is a base station that includes a processor adapted to associate each of N index numbers, assigned to individual users, with a kth scheduling position of an ordered list of M network allocations. The processor is also adapted to generate a signaling word having a maximum of ceil(M*log 2(N+1)) bits that allocates the M network allocations among the N users. The signaling word includes the index numbers sequenced according to their respective kth position in the list. The base station further includes a transmitter, having an input coupled to an output of the processor, adapted to wirelessly send the signaling word to the N users. The values N and M are each integers greater than one and the function ceil rounds to a next highest integer.

In another exemplary aspect of the invention there is an apparatus that includes means for generating a signaling word having a maximum of ceil(M*log 2(N+1)) bits that allocates M network allocations among N users by sequencing index numbers assigned to the N users to an ordered list of the M network allocations. The apparatus further includes means for wirelessly signaling the signaling word to the N users. The values N and M are each integers greater than one and the function ceil rounds to a next highest integer.

In an exemplary aspect of the invention, the means for generating includes a processor coupled to a memory, and the means for wirelessly signaling includes a transmitter.

In another exemplary aspect of the invention there is a method that includes determining an assigned index number and a total number M of network allocations to be allocated, and wirelessly receiving a signaling word having a maximum of ceil(M*log 2(N+1)) bits, wherein N and M are each integers greater than one and the function ceil rounds to a next highest integer. Further in the method, from the signaling word is determined which of the M network allocations are allocated to the assigned index number; and transmitting on a physical resource block of the determined network allocation.

In yet another exemplary aspect of the invention there is a mobile station that includes a memory adapted to store an assigned index number and a total number M of network allocations to be allocated, and a receiver adapted to wirelessly receive a signaling word having a maximum of ceil(M*log 2(N+1)) bits, wherein N and M are each integers greater than one and the function ceil rounds to a next highest integer. The mobile station further includes a processor, adapted to determine from the signaling word, which of the M network allocations are allocated to the assigned index number; and a transmitter that is adapted to transmit on a physical resource block of the determined network allocation.

### DESCRIPTION OF THE DRAWINGS

The foregoing and other aspects of embodiments of this invention are made more evident in the following Detailed Description, when read in conjunction with the attached Drawing Figures, wherein:

FIGS. 1 and 2 depict prior art physical channel structure and physical channel parameters that are useful context in explaining the exemplary embodiments of this invention.

FIG. 3 shows a simplified block diagram of various electronic devices that are suitable for use in practicing the exemplary embodiments of this invention.

FIG. 4 graphically illustrates a savings achieved by the signaling in accordance with the exemplary embodiments of this invention, as compared to so-called smart signaling.

FIG. 5 illustrates a method of the invention for compressing and encoding signaling bits for a user signal.

FIG. 6 illustrates a method of the invention for decoding a signal comprising received signaling bits encoded by the invention.

FIG. 7 illustrates a flow diagram of an integrated circuit according to an exemplary embodiment of the invention.

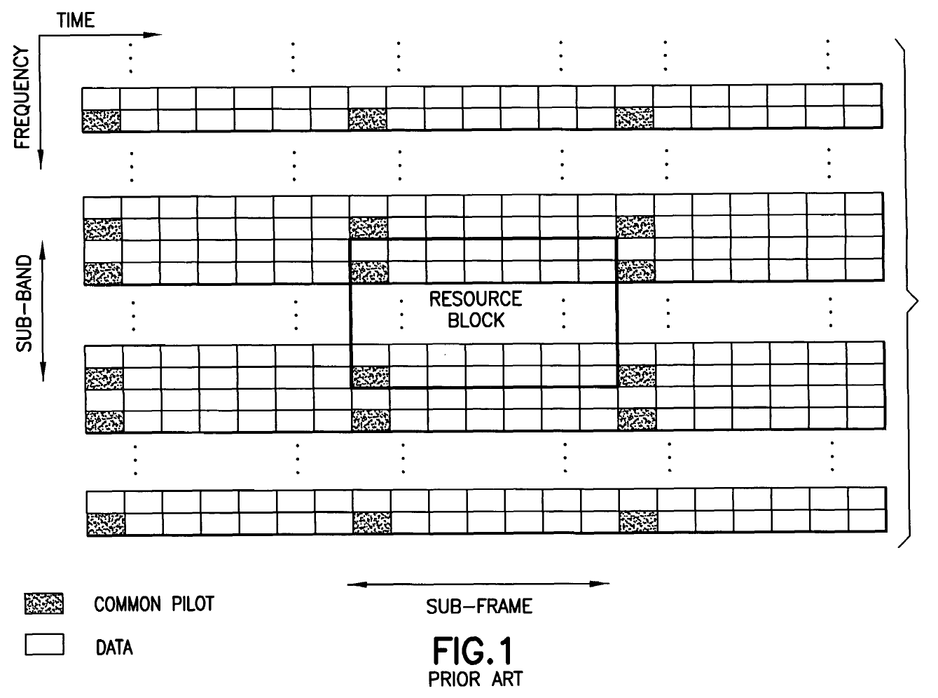

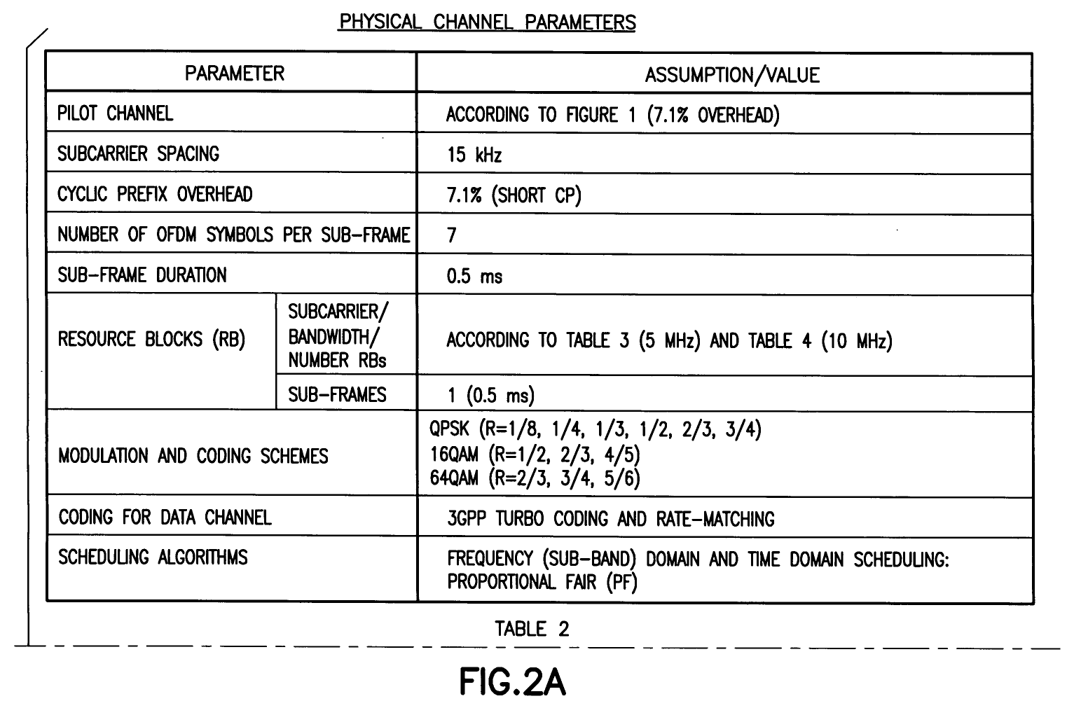

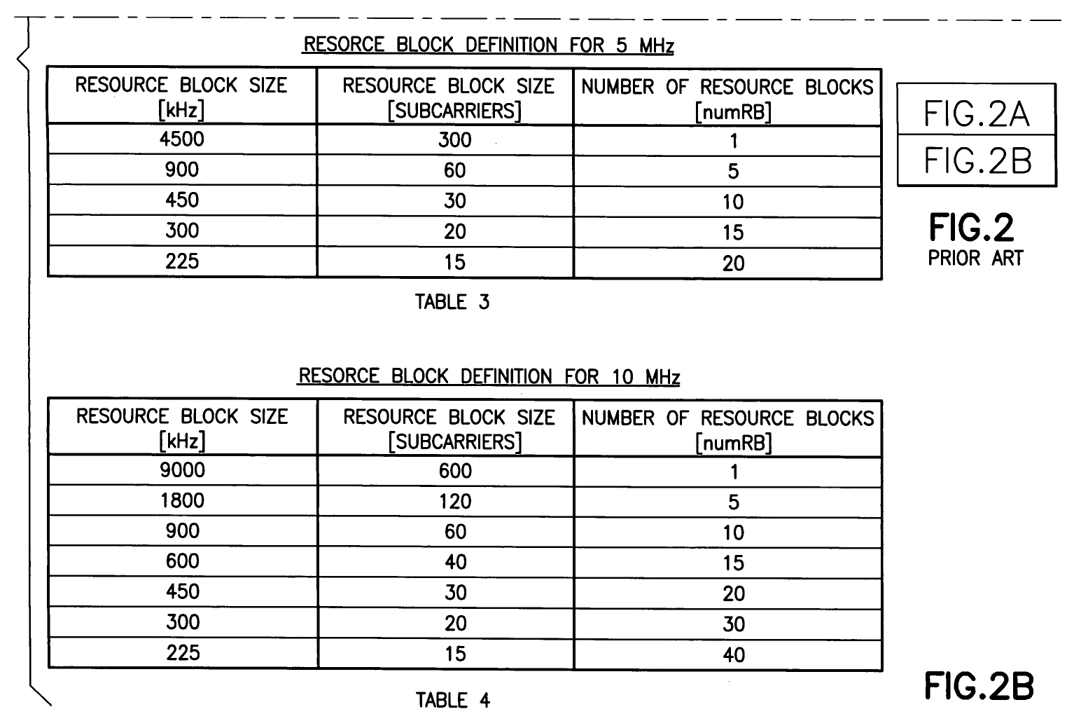

### DETAILED DESCRIPTION

The exemplary embodiments of this invention relate to signaling of frequency domain packet scheduling decisions, although it should be appreciated that the exemplary embodiments of this invention may find wider use, and may be advantageously employed wherever efficient signaling is desired.

The inventors have realized that a problem can exist with a packet scheduler/link adaptation unit that may find that a varying number of users would provide the best efficiency in terms of system capacity. That is, for one allocation period (sub-frame or transmit time interval in 3GPP) a best solution may be to schedule three users, while for the next sub-frame a better solution may be to schedule five users. These scheduling decisions then need to be communicated to the UEs in the system. A so-called allocation table may be used for this purpose, where the allocation table carries information on the number of users allocated, as well as an identity for these users as a (Radio Link ID or RLID).

For a LTE study item, a number of sub-carriers of the OFDM symbol may be grouped into a minimum scheduling unit (frequency chunk or physical resource block, sometimes also referred to as a resource pool). The size of these frequency partitions or physical resource blocks has been set to 180 kHz, corresponding to a grouping of 12 consecutive sub-carriers. For a 10 MHz system bandwidth, this would result in 50 physical resource blocks. As another non-limiting example, the default system bandwidth could be 20 MHz, resulting in a set of 100 physical resource blocks to be signalled. There are different possible approaches to indicate the allocations for users in the case of full dynamic allocations in the frequency domain (for the examples given below, M will denote the number of frequency resource blocks, and N will denote the number of allocated users).

In an approach 1, each UE is given a bit mask (on/off), which may be the simplest method, but one that also requires the greatest overhead in terms of control signaling. This method would require M*N signaling bits.

In an approach 2, the resource allocation map is made dependent on the allocations for other users, such that only the resources not assigned to other users are signaled for subsequent users. This approach would require M+(M−1)+(M−1−1)+ . . . +(M−N) bits in a worst case (i.e., only a slight reduction of signaling complexity as compared to approach 1). Significantly, it can be seen that the UE does not have a priori knowledge of the length of the resource field. This lack of knowledge can result in problems being encountered, as error protection and detection will become cumbersome as the location of a cyclic redundancy check CRC field is unknown.

In an approach 3, a number of bits are reserved for each resource pool signaling event, such that each resource pool requires ceil(log 2(N+1)), and the total number of bits required is M*ceil(log 2(N+1)), where ceil designates a ceiling function. As the UE has knowledge of both N and M, it then also knows the size of the resource field.

All the above approaches are quite straight forward, but they are not deemed optimum in terms of signaling considering that N (the number of allocated users) may vary from sub-frame to sub-frame.

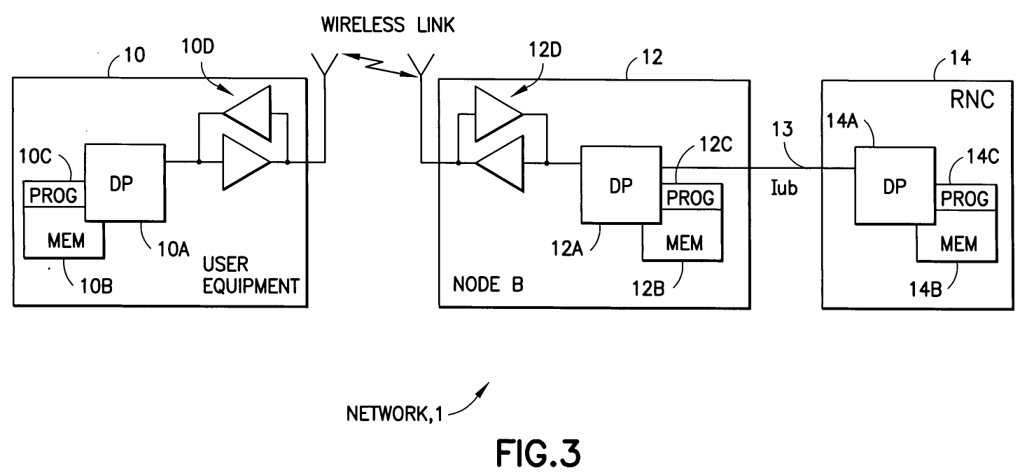

Reference is now made to FIG. 3 for illustrating a simplified block diagram of various electronic devices that are suitable for use in practicing the exemplary embodiments of this invention. In FIG. 3 a wireless network 1 is adapted for communication with a UE 10 via a Node B (base station) 12. The network 1 may include a RNC 14, which may be referred to as a serving RNC (SRNC). It is noted that in LTE of 3GPP, certain functionality of a conventional RNC is moved to the NodeB. The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The Node B 12 is coupled via a data path 13 (lub) to the RNC 14 that also includes a DP 14A and a MEM 14B storing an associated PROG 14C. The RNC 14 maybe coupled to another RNC (not shown) by another data path 15 (lur). At least one of the PROGs 10C, 12C and 14C is assumed to include program instructions that, when executed by the associated DP, enable the electronic device to operate in accordance with the exemplary embodiments of this invention, as will be discussed below in greater detail.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by the DP 10A of the UE 10 and other DPs, such as the DP 12A of the Node B, or by hardware, or by a combination of software and hardware.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

As will now be described, the exemplary embodiments of this invention provide an efficient method of signaling which yield an optimum solution for any number of user allocations. The signaling approach and algorithm in accordance with the exemplary embodiments of this invention beneficially compress the user signal space such that the-total required number of signaling bits becomes ceil(M*log 2(N+1)).

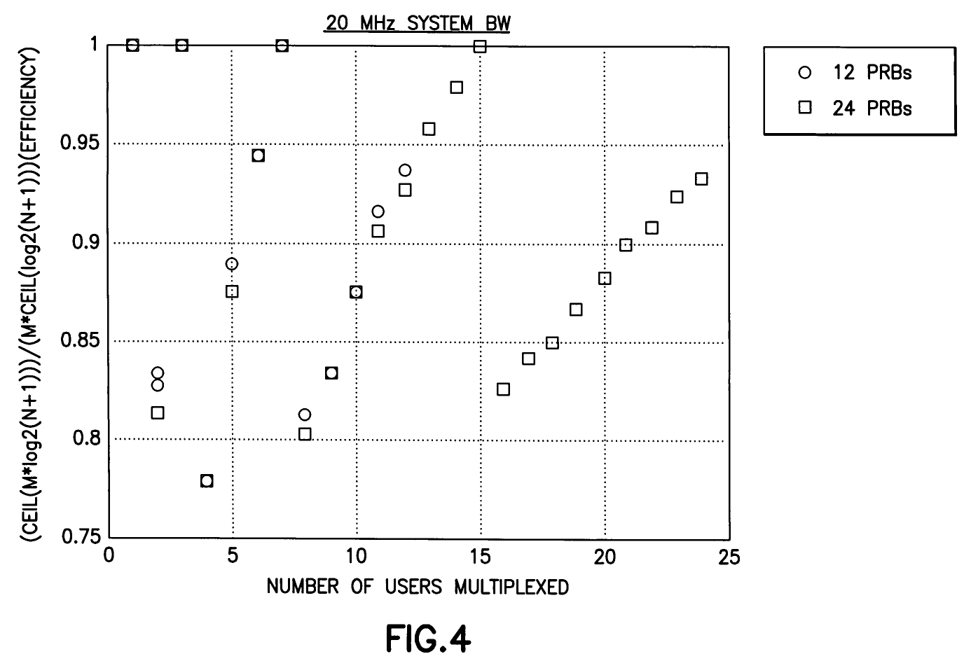

Note that this solution is some what similar to Approach 3 discussed above i.e., M*ceil(log 2(N+1)), however further signaling savings are realized by moving the “ceil” function field. As an example, FIG. 4 illustrates in a plot graph the resulting efficiency of a number of users multiplexed on a 20 MHZ system bandwidth as calculated with the expression ceil(M*log 2(N+1)) over the algorithm M*ceil(log 2(N+1)).

The expressions below illustrate a signaling overhead comparison between the prior art (left) and an exemplary embodiment of the invention (right). As shown, for a case of M=24 and N=4, a 22% a savings in signaling overhead is realized (from 72 to 56 bits), and for a case of M=12, N=8, a 19% a savings in signaling overhead is realized (from 48 to 39 bits).

| M * ceil(log2(N + 1)) | ceil(M * log2(N + 1)) |
|---|---|
| 24 * ceil(log2(4 + 1)) = 72 | ceil(24 * log2(4 + 1)) = 56 |
| 12 * ceil(log2(8 + 1)) = 48 | ceil(12 * log2(8 + 1)) = 39 |

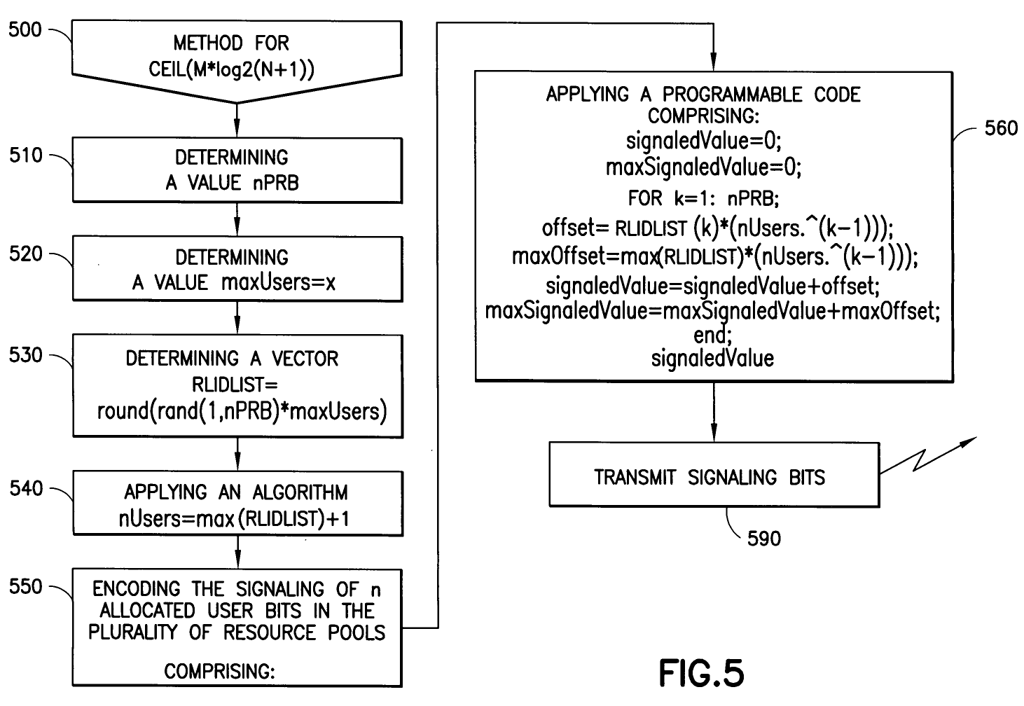

Referring to FIG. 5, for a resulting total of a required number of signaling bits that can be calculated with the expression ceil(M*log 2(N+1)) a method 500 is performed. The method includes: determining 510 a value nPRB, determining 520 a value maxUsers=x, determining 530 a vector RLIDLIST, applying 540 an algorithm for nUsers, and encoding 550 the signaling of n allocated user bits in the plurality of physical resource blocks, comprising applying 560 a programmable code as shown, and then sending to a transmitter 590 for transmitting the encoded signaling bits. The signaling bits described herein form a signaling word that gives the allocation of M and the resource blocks among the Nusers. It is noted that a message carrying the signaling word may also carry additional bits (eg. FEC bits), but since they do not allocate resources, they are not part of the signaling word.

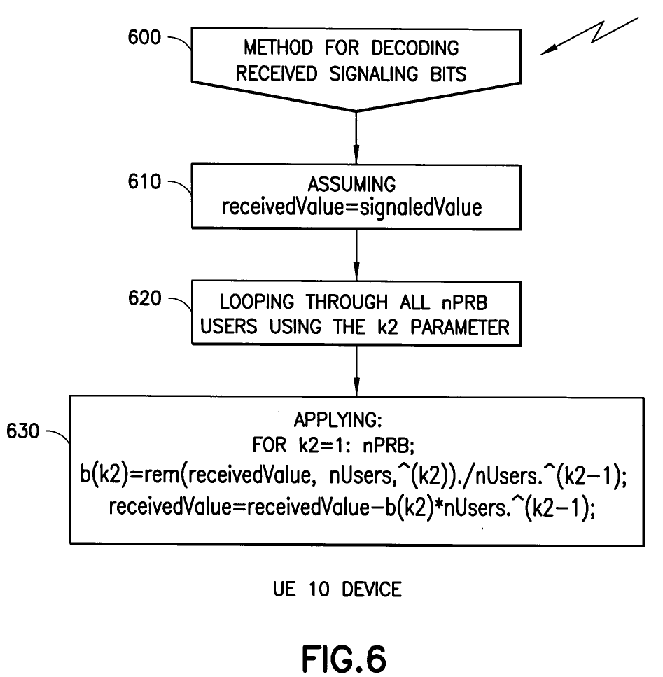

In reference to FIG. 6, the received signaling bits are decoded at the UE 10 using an exemplary embodiment of the invention. The method 600 for decoding received signaling bits is illustrated, assuming 610 the received Value equals the signaledValue, then a decoding algorithm is applied for looping through all nPRB users using the k2 parameter 620, and a method for applying 630 programmable code as shown here, to decode each single signaled value for k2=1 :nPRB.

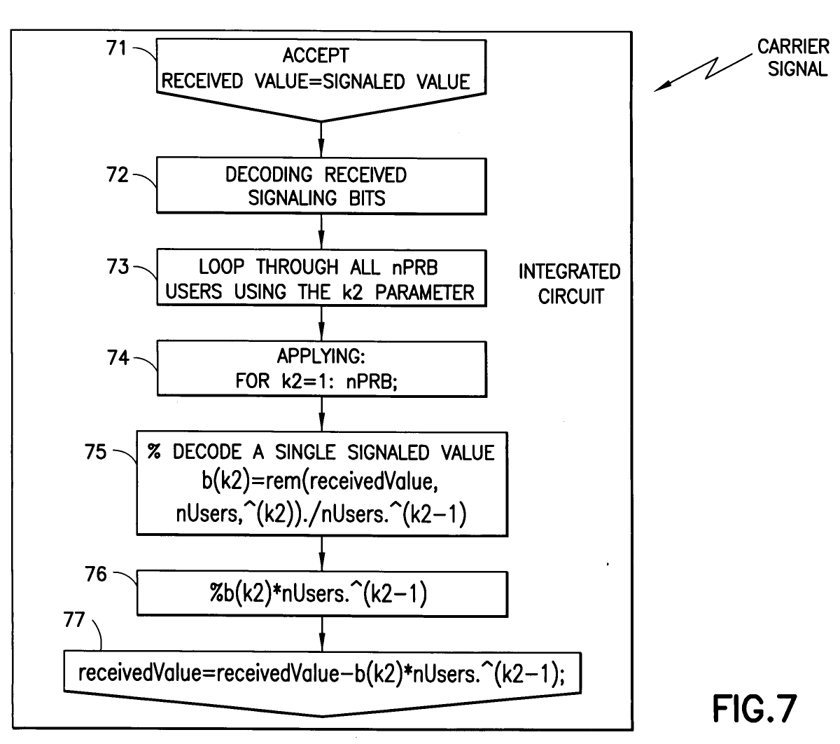

Referring to illustration in FIG. 7 is another exemplary embodiment of the invention, wherein an integrated circuit includes a circuit for determining a value nPRB 72, where nPRB denotes an available number of the plurality of physical resource blocks, determining a value maxUsers 73, where maxUsers is a number of allocated users in each of the plurality of physical resource blocks, determining a vector RLIDLIST 74 where RLIDLIST corresponds to a random allocation of the value maxUsers to a scheduling position, to illustrate the potential of the algorithm, in this block 75 the maximum number from the RLIDLIST is used, applying a programmable code 76 as illustrated, and the final signal denoted as signaledvalue, which may be locally stored in decimal or binary form. (The term dec2bin indicates a MatLab™ function that transforms from decimal to binary.)

The following Matlab™ algorithm illustrates an exemplary technique for generating the signaling word for a user. Note that this Matlab™ implementation is exemplary, as the procedure may be expressed in a number of other formats, such as C++formats. The algorithm may be executed in, for example, the Node B 12 of FIG. 3, or at any suitable location in the network infrastructure. The Node B 12 may be a preferred location as, in accordance with the LTE of 3GPP, at least some resource scheduling decisions are made in the Node B 12, and thus the encoding of the resource allocation information would likely be performed there as well. The subsequent decoding of the signaled resource allocation information is performed in the UE 10.

The following notation is used, which maps to the description above. First, the number of physical resource blocks (PRB) available is denoted by nPPB (referred to previously as M), and the number of users multiplexed in the system is denoted as nUsers (denoted simply as N previously):

nPRB=12.

Here, one makes a random allocation of the users corresponding to a possible scheduling position (list of users may be entered manually). The notation is that the RLIDLIST vector has a length of nPRB and contains integers indicating which user number is allocated to each resource pool position. ‘0’ is used to indicate a situation where a resource pool has not been allocated to any user. It is important to note that comments follow a % symbol.

maxUsers=10.

RLIDLIST=round(rand(1,nPRB)*maxUsers).

### Ideally, one may limit the user domain only to the active user set, but to illustrate the potential of the algorithm, in the following the maximum number from the RLIDLIST is used.

nUsers=max(RLIDLIST)+1.

In the next sequence of code, the signaling of user allocation is encoded. Thereafter, the final signal denoted as signaledvalue is stored (e.g., in decimal or binary form).

```
signaledValue=0;
maxSignaledValue=0;
for k=1:nPRB;
    offset=RLIDLIST(k)*((nUsers.\hat{ }(k−1)));
    maxOffset=max(RLIDLIST)*((nUsers.\hat{ }(k−1)));
    signaledValue=signaledValue+offset;
    maxSignaledValue=maxSignaledValue+maxOffset;
end
dec2bin(signaledValue);
%sum(nUsers.\hat{ }(0:11).*a)
```

What is shown now is the decoding of the signaling value at the UE 10

receivedValue=signaledValue;

### In the following code operation is the UE 10 decoding algorithm for looping through all nPRBs using the k2 parameter.

```
for k2=1:nPRB,
    % Decode a single signaled value
    b(k2)=rem(receivedValue, nUsers.\hat{ }(k2))./nUsers.\hat{ }(k2−1);
    % remove this value
    % b(k2)*nUsers.\hat{ }(k2−1)
    receivedValue=receivedValue−b(k2)*nUsers.\hat{ }(k2−1);
end
```

While the encoding and decoding may be slightly more complex than that which is required to realize the approach 3 above, it is also assured that the optimum numbers of signaling bits are used for allocation signaling. Furthermore, the algorithm is general, and can be used for other systems and applications requiring optimum signaling. For example, the algorithm may be used for transmission of multidimensional information, such that for instance scheduling information can be combined with physical resource block dependent modulations. In this case, the modulation order will increase the dimensionality of the signaling space, but may still be incorporated into the signaling scheme. For the general case then, the value M may represent any number of unique entries in the list RLIDLIST. As particularly detailed in the examples herein, M represents the number of physical resource blocks, but it may also represent a number of unique combinations of physical resource block and modulation as above, or some other specific arrangement by which the network chooses to allocate to the individual N users.

Above it is shown that a signaling word is created having a maximum of ceil(M*log 2(N+1)) bits to allocate M physical resource blocks among N users. Every one of the N users under control of the base station is assigned a user index number (e.g., 001 for User1, 010 for User2, 111 for User3, 110 for User4, 000 for User5). Each of the N users has stored a RLIDLIST of the physical resource blocks in a known order, and each of the users already knows at least its own assigned index number, and in some embodiments all user's assigned index numbers. The signaling word comprises an ordered sequence of the user index numbers. The order of the user index numbers in the signaling word corresponds to the order of the physical resource blocks in the RLIDLIST. The position of the user's assigned index number, in the signaling word that allocates the M physical resource blocks for an allocation interval (e.g., one OFDM sub-frame or transmit time interval), corresponds to the position of one resource pool in the RLIDLIST. The base station therefore generates the signaling word by associating user index numbers with physical resource blocks in the list, which may be a random association. The users determine their resource pool allocations by associating index numbers at each kth position in the signaling word with the resource pool at the kth position of the RLIDLIST.

For example, user1 receives a signaling word from a base station, and associates each index number at a kth position in the signaling word with a resource pool at a kth scheduling position in the stored RLIDLIST. Every kth scheduling position of the RLIDLIST at which the index number assigned to user1 appears is an allocation to user1 of the physical resource block at that kth scheduling position of the list. User1 determines his resource allocation in this manner, and transmits or receives on the determined resource pool(s) during the period the allocation is valid. Each of the users does the same for that same signaling word, so the one signaling word of maximum length ceil(M*log 2(N+1)) bits allocates each of the M physical resource blocks among the N users.

Based on the foregoing it should be apparent that the exemplary embodiments of this invention provide a method, apparatus and computer program product(s) to optimize a number of signaling bits transmitted through a channel, such as signaling bits used to convey a resource allocation to a UE, as well as to decode such a transmission at a receiver, such as at a UE receiving a resource allocation from a wireless network element or device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
obtaining an ordered list of M network allocations each in a kth position of the list;
assigning an index number to each of N users;
for each kth position of the list, associating one of the index numbers with the network allocation at the kth position;
generating a signaling word having a maximum of ceil(M*log 2(N+1)) bits, the signaling word comprising the index numbers sequenced according to their respective kth position in the list; and
transmitting the signaling word to the N users,
wherein N and M are each integers greater than one and the function ceil rounds to a next highest integer.

2. The method of claim 1, wherein the M network allocations consist of M physical resource blocks.

3. The method of claim 1, wherein the M network allocations consist of M unique combinations of physical resource blocks and modulation.

4. The method of claim 1, wherein associating comprises randomly associating.

5. The method of claim 1, wherein generating the signaling word comprises executing the algorithm:
```
signaledValue=0;
maxSignaledValue=0;
for k=1:M;
    offset=RLIDLIST(k)*((N\hat{ }(k−1)));
    maxOffset=max(RLIDLIST)*((N\hat{ }(k−1)));
    signaledValue=signaledValue+offset;
    maxSignaledValue=maxSignaledValue+maxOffset;
end;
signaledValue;
```
where signaledValue is the signaling word in decimal form and RLIDLIST is the ordered list.

6. The method of claim 5, wherein the network allocation is valid for one OFDM subframe and the method is repeated for a plurality of OFDM subframes during which each of the N users that are allocated over the plurality of OFDM subframes is assigned a same index number.

7. The method of claim 1 executed by a NodeB of a wireless network.

8. A computer program product embodied on a memory and executable by a processor to generate a signaling word by performing actions comprising:
assigning an index number to individual ones of N users;
associating the index numbers with each of M network allocations in an ordered list;
determining a kth scheduling position in the list for each of the associated index numbers; and
outputting a signaling word having a maximum of ceil(M*log 2(N+1)) bits that allocates the M network allocations among the N users, where the signaling word comprises the index numbers sequenced according to their respective kth positions in the list, where N and M are each integers greater than one and the function ceil rounds to a next highest integer.

9. The computer program of claim 8, wherein the M network allocations consist of M physical resource blocks.

10. The computer program product of claim 8, wherein the M network allocations consist of M unique combinations of physical resource block and modulation.

11. The computer program product of claim 8, wherein associating comprises randomly associating.

12. The computer program product of claim 8, wherein determining comprises executing the algorithm:
```
signaledValue=0;
maxSignaledValue=0;
for k=1:M;
    offset=RLIDLIST(k)*((N\hat{ }(k−1)));
    maxOffset=max(RLIDLIST)*((N\hat{ }(k−1)));
    signaledValue=signaledValue+offset;
    maxSignaledValue=maxSignaledValue+maxOffset;
end;
signaledValue;
```
where signaledValue is the signaling word in decimal form, and RLIDLIST is the ordered list.

13. The computer program product of claim 8, wherein the network allocation is valid for one OFDM subframe and the method is repeated for a plurality of OFDM subframes during which each of the N users that are allocated over the plurality of OFDM subframes is assigned a same index number.

14. A base station, comprising
a processor adapted to associate each of N index numbers assigned to individual users with a kth scheduling position of an ordered list of M network allocations, and to generate a signaling word having a maximum of ceil(M*log 2(N+1)) bits that allocates the M network allocations among the N users, the signaling word comprising the index numbers sequenced according to their respective kth positions in the list,; and
a transmitter having an input coupled to an output of the processor, adapted to wirelessly send the signaling word to the N users,
wherein N and M are each integers greater than one and the function ceil rounds to a next highest integer.

15. The base station of claim 14, where the M network allocations consist of M physical resource blocks.

16. The base station of claim 14, wherein the M network allocations consist of M unique combinations of physical resource block and modulation.

17. The base station of claim 14, wherein the processor is adapted to associate each of the N index numbers with a kth scheduling position randomly.

18. The base station of claim 14, wherein the processor is adapted to generate the signaling word by executing the algorithm:
```
signaledValue=0;
maxSignaledValue=0;
for k=1:M;
    offset=RLIDLIST(k)*((N\hat{ }(k−1)));
    maxOffset=max(RLIDLIST)*((N\hat{ }(k−1)));
    signaledValue=signaledValue+offset;
    maxSignaledValue=maxSignaledValue+maxOffset;
end;
signaledValue;
```
where signaledValue is the signaling word in decimal form and RLIDLIST is the ordered list.

19. The base station of claim 14, wherein the network allocation is valid for one OFDM subframe and the method is repeated for a plurality of OFDM subframes during which each of the N users that are allocated over the plurality of OFDM subframes is assigned a same index number.

20. An apparatus, comprising
means for generating a signaling word having a maximum of ceil(M*log 2(N+1)) bits that allocates M network allocations among N users by sequencing index numbers assigned to the N users to an ordered list of the M network allocations; and
means for wirelessly signaling the signaling word to the N users,
wherein N and M are each integers greater than one and the function ceil rounds to a next highest integer.

21. The apparatus of claim 20,
wherein the means for generating the signaling word comprises a processor coupled to a memory, and
wherein the means for wirelessly signaling comprises a transmitter.

22. A method comprising:
determining an assigned index number and a total number M of network allocations to be allocated;
wirelessly receiving a signaling word having a maximum of ceil(M*log 2(N+1)) bits, wherein N and M are each integers greater than one and the function ceil rounds to a next highest integer;
from the signaling word, determining which of the M network allocations are allocated to the assigned index number; and
transmitting on a physical resource block of the determined network allocation.

23. The method of claim 22, wherein the M network allocations consist of M physical resource blocks.

24. The method of claim 22, wherein the M network allocations consist of M unique combinations of physical resource block and modulation, and wherein transmitting comprises transmitting on the determined physical resource block using the determined modulation.

25. The method of claim 22, wherein determining which of the M network allocations are allocated to the assigned index number comprises:
determining each kth position in the signaling word at which the assigned index number appears;
at least for the assigned index number, associating the index number at the kth position with a resource pool at a corresponding kth scheduling position of a locally stored list RLIDLIST of the M network allocations; and
from the RLIDLIST list with the associated index number, determining which of the M network allocations are associated with the assigned index number.

26. The method of claim 25, wherein determining which of the M network allocations are allocated to the assigned index number comprises executing the algorithm:
for k=1:M;
b(k)=rem(receivedValue, N\hat{ }(k))/N\hat{ }(k−1);
receivedValue=receivedValue−b(k)*N\hat{ }(k−1);
end;
where k represents the kth position in the signaling word of an index number and receivedValue represents the signaling word.

27. A mobile station, comprising:
a memory adapted to store an assigned index number and a total number M of network allocations to be allocated;
a receiver adapted to wirelessly receive a signaling word having a maximum of ceil(M*log 2(N+1)) bits, wherein N and M are each integers greater than one and the function ceil rounds to a next highest integer;
a processor adapted to determine from the signaling word which of the M network allocations are allocated to the assigned index number; and
a transmitter adapted to transmit on a physical resource block of the determined network allocation.

28. The mobile station of claim 27, wherein the M network allocations comprise M physical resource pools.

29. The mobile station of claim 27, wherein the M network allocations consist of M unique combinations of physical resource pool and modulation.

30. The mobile station of claim 27, wherein said processor is adapted to determine which of the M network allocations are allocated to the assigned index number by:
determining each kth position in the signaling word at which the assigned index number appears;
at least for the assigned index number, associating the index number at the kth position with a network allocation at a corresponding kth scheduling position of a locally stored list RLIDLIST of the M network allocations; and
from the RLIDLIST list with the associated assigned index number, determining which of the M network allocations are associated with the assigned index number.

31. The mobile station of claim 30, wherein associating the index number at the kth position comprises executing the algorithm:
for k=1:M;
b(k)=rem(receivedValue, N\hat{ }(k))/N\hat{ }(k−1);
receivedValue=receivedValue−b(k)*N\hat{ }(k−1);
end;
where k represents the kth position in the signaling word of an index number and receivedValue represents the signaling word.
